(19) United States
(12) Patent Application Publication
(10) Pub. No.: US 2015/0358663 A1
(43) Pub. Date: Dec. 10, 2015

(54) PERSONAL LINEAR CHANNEL

(71) Applicant: TELEFONAKTIEBOLAGET L M ERICSSON (PUBL), Stockholm (SE)

(72) Inventors: Edward Malone, Mountain View, CA (US); Sean Pickton, Mountain View, CA (US); Ignazio Moresco, San Francisco, CA (US); Kah Loon Liew, Campbell, CA (US); Kumi Akiyoshi, San Francisco, CA (US)

(21) Appl. No.: 14/481,519

(22) Filed: Sep. 9, 2014

Related U.S. Application Data
(60) Provisional application No. 62/009,368, filed on Jun. 9, 2014.

(51) Int. Cl. H04N 21/2668; H04N 21/235; H04N 21/258; H04N 21/262; H04N 21/2665

(52) U.S. Cl. CPC H04N 21/2668; H04N 21/26283; H04N 21/2665; H04N 21/25891; H04N 21/2353

(57) ABSTRACT

A method for generating a personal linear channel is described. The method includes receiving a request from a client device associated with a subscriber account to generate a personal linear channel, wherein the request includes an indicator of desired content for the personal linear channel. The method also includes selecting a plurality of related content items related to the indicator of desired content from one or more disparate content sources based on content that is associated with the indicator of desired content and based on consumption statistics of the subscriber account. The method further includes sending the plurality of related content items to the client device to cause the client device to display indicators of the plurality of related content items in a linear channel interface.

### CLAIM OF PRIORITY

This application claims the benefit of U.S. Provisional Application No. 62/009,368 filed on Jun. 9, 2014. The contents of this document are hereby incorporated by reference herein.

### FIELD

Embodiments of the invention relate to the field of television; and more specifically, to personal linear channels.

### BACKGROUND

Television operators commonly broadcast TV channels that originate from a TV operators facility and are delivered to the consumer substantially in real time irrespective of the delivery mechanism (e.g., Internet Protocol television (IPTV), Cable, Satellite, etc.). These types of TV channels are known as “linear channels.” The content of a linear channel is selected by the owner of the channel and is typically the same for all consumers. The content of the linear channel may include a live TV program such as a sporting event or news that is broadcast to the viewer substantially at the same time as the event is happening. The content of the linear channel may also include programs or movies that were produced or broadcast at an earlier point in time and are now stored as video assets in one or more digital libraries (referred herein as “library programs”). For example, many programs that are broadcast over a linear channel are library programs that have been aired or produced at a previous time. This is especially true for cable channels that almost exclusively broadcast a series of library programs where new episodes in the series are produced well in advance of their initial broadcast.

### BRIEF DESCRIPTION OF THE DRAWINGS

The invention may best be understood by referring to the following description and accompanying drawings that are used to illustrate embodiments of the invention. In the drawings:

FIG. 1 illustrates a block diagram for generating personal linear channels according to an embodiment of the invention.

FIG. 2 illustrates an exemplary electronic programming guide (EPG) user interface for a personal linear channel according to one embodiment of the invention.

FIG. 3 illustrates an exemplary content item view user interface for a personal linear channel according to one embodiment of the invention.

FIG. 4 illustrates another exemplary subsequent content item view user interface for a personal linear channel according to one embodiment of the invention.

FIG. 5 illustrates another exemplary electronic programming guide (EPG) user interface 500 for a personal linear channel according to one embodiment of the invention.

FIG. 6 illustrates an exemplary channel edit user interface for a personal linear channel according to one embodiment of the invention.

FIG. 7 is a flow diagram illustrating a method 700 in a server device for generating a personal linear channel according to an embodiment of the invention.

FIG. 8 illustrates a block diagram for an exemplary data processing system that may be used in some embodiments.

### DESCRIPTION OF EMBODIMENTS

The following description describes methods and apparatus for generating personal linear channels. In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with an embodiment whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

A method and apparatus generating personal linear channels is described herein. In one embodiment, a personal linear channel is created for a particular user. This channel may be theme-based (e.g., cooking), keyword-based, actor-based, director-based, genre-based (e.g. dark-comedy) show-based (e.g., all episodes of a specific season of a specific show) or network-based. The user may provide an initial piece of information (e.g., a search term or keyword) or guidance (e.g., Italian cooking shows) that may be used to create a personal linear channel based on content that is associated with that initial piece of information and/or based on user-specific analytics. The origin of the video assets used to create the personal linear channel may come from a number of different sources such as from one or more of: a network source providing live content, a television operator video on demand source, a third party provider content aggregator Internet source, a third party provider content owner Internet source, a digital video recorder of the subscriber account, an advertisement source, and a television operator restart television source. Thus the content is source-agnostic and may be sourced from different locations without requiring the user to navigate to different locations within the TV experience to view the content. By way of a specific example, the system could tune to live or VOD video streams originating from the television operator, network broadcaster, or other third party video provider without specifically navigating between the different types of video sources. The created personal linear channel may then be served to the user in the form of a video playlist in which the user may have the ability to skip, add, and/or remove programs from the playlist. The personal linear channel may be added to an electronic program guide (EPG) that displays the programs in the order that they will be shown if watching the content of the personal linear channel.

According to embodiments of the invention, a server device receives a request from a client device associated with a subscriber account to generate a personal linear channel. The request also includes an indicator of the desired content or type of content that should be used to populate the personal linear channel. The indicator may describe a topic, theme, actor, show, keyword, broadcast channel, etc. In some embodiments, the second device is a set top box or smart television in an Internet Protocol television system. The server device then selects a plurality of related content items related to the indicator of desired content from a plurality of content sources. These sources may be from a network source providing live content, a television operator video on demand source, a third party provider content aggregator Internet source, a third party provider content owner Internet source, a digital video recorder of the subscriber account, an advertisement source, and a television operator restart television source. The related content items are selected based upon data in a recommendation data store. The server device inputs the indicator to the recommendation data store to look up related content. The recommendation data store includes associations and weighting values between the indicator and related content based on the consumption statistics of other subscriber accounts, and associations and weighting values between the indicator and related content based on the consumption statistics of the subscriber account.

The data store may be a directed graph, schema-less database (e.g. a NoSQL database) relational database, adjacency list, or any other data structure capable of storing associations between different items. In some embodiments, the recommendation data store also includes associations between the indicator and related content items that are determined based on an analysis of the terms in the indicator against external sources of information. In some embodiments, these external sources of information include metadata regarding the available content items from the content sources, and may include sources such as the Internet. Using the recommendation data store, the server device is able to select content items that are likely to be related to the desired content described in the indicator, and which also fit the consumption statistics of the subscriber account. These consumption statistics may include the consumption habits of a subscriber account, and may also include feedback from the user regarding content items in the personal linear channel.

For example, if the indicator is for cooking, the data store may include associations with popular cooking shows based on the consumption statistics of other subscriber accounts, and also may also weight particular cooking shows higher based on, for example, the average length of shows that the subscriber account views at that particular time of day. The data store may also include associations with advertisement content related to previous advertisements that the subscriber account has previously watched and not skipped, and also related to the indicator. After selecting the related content based on the recommendation data store, the server device sends the related content, e.g., cooking related content, to the client device to cause the client device to display the related content items in a linear channel interface.

Unlike current systems, which present channels that have been arranged by a third party, this system allows a user to view content and advertisements customized to the indicator of desired content and also customized to a subscriber account's consumption statistics. One potential advantage is that the user is able to engage more with the content provided by the system and this may generate more ad revenue for the broadcast provider and the content providers. Another potential advantage is that the broadcast provider is able to gather more information on viewing habits and/or consumption statistics and what subscribers are interested in. Yet another advantage is an ability of the personal channel provider to charge a premium to an advertiser to target advertising within certain channels as “paid” or “priority” ad placement.

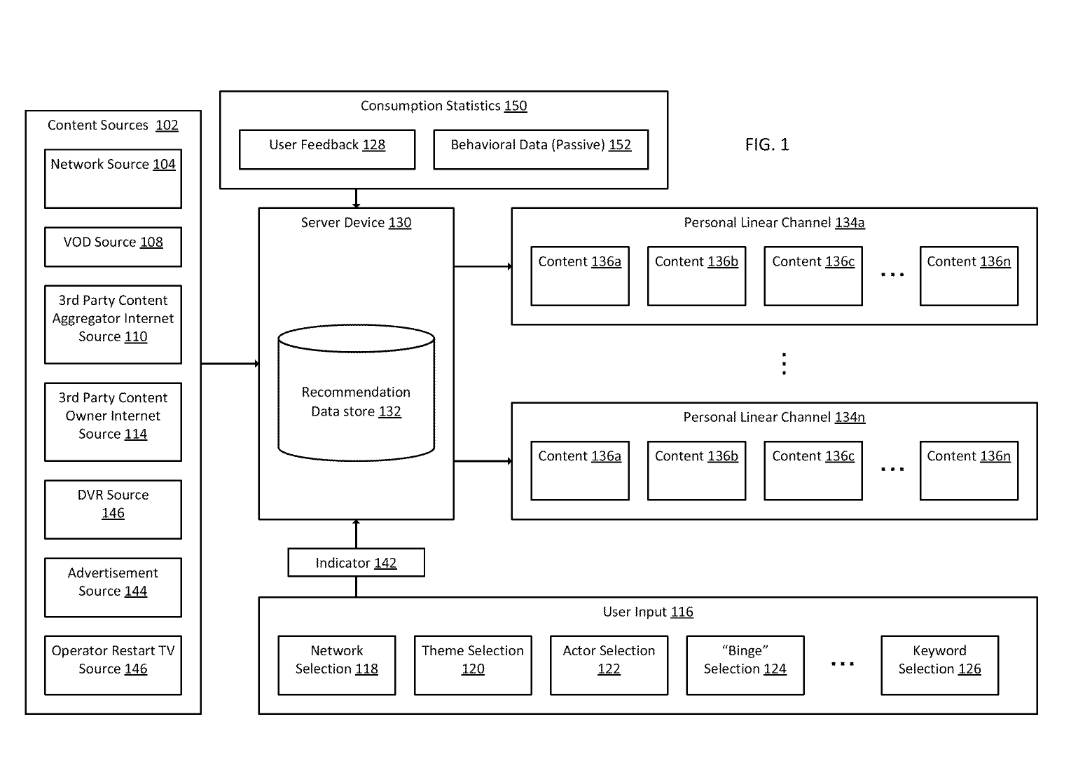

FIG. 1 illustrates a block diagram for generating personal linear channels according to an embodiment of the invention. The system includes content sources 102, user input 116, an indicator 142 of desired content, a server device 130, a recommendation data store 132, and one or more personal linear channels 134, each with content items. In some embodiments, the content sources 102 may each reside on different servers, or share servers in common. In some embodiments, the server device 130 is a software and hardware component of a channel provider, such as an IPTV provider/operator. In some embodiments, the server device 130 receives user input 116 from a client device. The client device may be a laptop computer, desktop computer, mobile phone, tablet device, e-reader device, head mounted display, wearable device, internet connected television, set top box, etc. In some embodiments, the content in the personal linear channels 134a-n is sent to the client device and is caused to be displayed by the client device or a display connected to the client device in a personal linear channel interface. Such an interface will also be described in greater detail in exemplary user interfaces below.

Content sources 102 include one or more sources that the system may use to select content items from when creating the personal linear channel for the user. These sources may include a network source 104. A network source 104 includes the live content (e.g., a live TV sports broadcast or news) that is delivered to a viewer substantially at the same time it is broadcast (a time-delayed event of over a few seconds is not considered to be live content) and stored content (e.g., a program that was produced or broadcast at an earlier point in time and is stored as a video asset in a digital library) provided by a particular network. Aside from live TV content, many programs that are broadcast over the network sources are library programs that have aired at a previous time. This is especially true for cable channels that almost exclusively broadcast series of library programs where new episodes in a series are produced well in advance of their initial broadcast. These networks include cable channels, broadcast channels, pay-per-view channels, etc. An example of such a network source is the FOX® broadcast channel of 21^{st} Century Fox, Inc. (New York City, N.Y.). A network source may also include content from local network affiliates, such as the local news broadcasts for a local affiliate.

These content sources 102 may include a video-on-demand (VOD) source 108. A VOD source is any source that provides video on demand that allows users to select and watch content at any time, and may include the VOD services of various network channels, and may also include video on demand services such as content rental sources. These may also include content items from the IPTV operator/provider, who may have licensed its own set of content items that it may use to generate the personal linear channel. The availability VOD sources may depend upon the subscriptions that a subscriber account has to the VOD sources. An example of a provider source 110 is the STREAMPIX® service of cable TV provider Comcast Corp. (Philadelphia, Pa.).

Content sources 102 may include a 3rd party content aggregator Internet source 110. Such a source 110 collects content items from various sources and is accessible via the Internet. A user may have to subscribe to such a service in order to use it, or the service may be ad supported. Such a service may also require a user to pay each time the user wishes to consume a content item from the source. An example of a 3rd party content aggregator Internet source is Netflix® of Netflix, Inc. (Los Gatos, Calif.).

Content sources 102 may include a 3rd party content owner Internet source 114. An internet source 114 is a source of content from the internet that includes content created by the owner or administrator of the source or by an entity whom the owner or administrator is associated with. This content may include various audio, visual, or audio/visual content items from various web sites and other providers and may include paid, ad-supported, or free content sources. Examples of internet sources are NHL.com of NHL (New York, N.Y.) and TED® of TED Conferences, LLC (New York, N.Y.).

Content sources 102 may include a digital video recorder (DVR) source 146. A DVR is a device which records or copies content to a storage medium for later playback. This content is recorded from content that is from a content source 102. The DVR device may be a specialized recording device, a set top box, a portable player, an audio/visual recording device, or a smart television, etc. The storage medium may be a disk drive, USB flash drive, memory card, solid state drive, or other mass storage device. The storage medium could also include cloud (e.g., where data is stored in logical pools that are supported by a flexible number of physical storage media) or network DVR storage. The DVR may record the content in a variety of formats that vary in quality and size of the file, in accordance with user or manufacturer defined settings. In some embodiments, the system can direct the DVR to record or copy those content items 136 from a content source 102 that the system has determined will become unavailable after a set period of time, or will be unavailable immediately. This allows the system to present highly desirable content to the subscriber even if that content may later become unavailable through the other available content sources.

Content sources 102 may include an advertisement source 144. An advertisement source is a source of advertisements. These may be supplied by the provider, or may be from an outside source. These contain various advertisements, which may be in text, audio, image, or video formats.

Content sources 102 may also include an operator restart TV source 146. Content from this source is recorded from a live source such as network source 104. The recording function is similar to that performed by a DVR source. However, the location of the recording may be on a remote server or device separate from a client device. At a point in time where the user decides to consume the program, the user may begin consuming the program from this source, and since the source has been recorded, the system may receive from the user play, pause, fast forwarding, and other playback controls indicators and be able to execute these playback controls on the content item as it has been recorded already. In contrast, the system would not be able to execute playback operations on live content. The user may decide to also pause or stop the playback of the content item from a restart TV source 146 and consume other content items. At this point, the operator restart TV source 144 may continue to record the content item, so that when the user decides to consume it again, the user may restart from the same point that he or she had previously paused or stopped the content item playback at. The user may do this even though the live content item from which the recording was made has completed its broadcast.

In some embodiments, each content item in the content sources 102 also includes one or more metadata descriptors that describe the content. Such descriptors may include a title, genre, intended audience, keywords, viewer rating, length, subtitles, language, creation date, image(s) (e.g., thumbnail), poster art, artwork, screen captures, etc. In some circumstances, content items from certain content sources 102 do not include metadata or include metadata incompatible with metadata from other content sources 102. In such cases, in some embodiments, the system conflates the metadata of content items from various sources and adds metadata elements where those elements do not exist based on an intelligent analysis of the content, source, and/or existing metadata of the content item. In some embodiments, the system matches the content with similar content present in other content sources in the system and attaches the metadata from the other content item to the content item being processed. In some embodiments, the system uses various object and facial recognition algorithms to determine the identity of objects, text, and persons in the content item in order to generate additional metadata for the item. The system may also analyze the length, quality, resolution, aspect ratio, displayed text, and other aspects of the media item to generate additional metadata for the item.

The system may further compare the generated metadata with a media catalog database to generate further metadata for a content item. For example, the system may determine the names of actors in a content item based on an analysis of the credits and faces in the content item, and based on a comparison with a media catalog database, the system may be able to determine the title of the content item and determine additional metadata for the item, such as its viewer rating, etc.

While the system acquires content from various content sources 102, it integrates the content acquired from these various sources into personal linear channels 134 without needing to have the user be aware of the sources of the content. Since the system is creating this personal channel virtually, the system could source the content from different locations without requiring the subscriber to navigate to different locations within the experience. For example, the system could tune to live or VOD content streams originating from the television operator, network broadcaster, or other 3rd party video provider to generate the channels, all without requiring the subscriber to interact with the selection method or be aware of where the content is sourced from.

Note that although a particular list of different content sources 102 is described above, the system is not limited to such content sources and may include many additional content sources 102 from different content providers. The content items available at these content sources is also not limited to audio/visual programs, and may be audio only, video only, interactive content such as video games, etc. In some embodiments, the system may also have fewer content sources 102 than those listed above. For example, the system may not utilize live sources, but instead only have sources that include recordings of previously live content items.

User input 116 provides to the system the indicator 142 of the desired content which the user of the subscriber account wishes to create a personal linear channel 134 of User input 116 may be a text string, an image, a feedback selection, an audio file, a video file, a natural language query, an ID number, etc.

Once the system receives user input 116, it consults a recommendation data store 132 to select content to display to the user based on the user input 116. The recommendation data store 132 includes associations between the indicator described by user input 116 and other related content items that are provided by the content sources 102. Those related content items that are associated with the indicator described by the user input are selected to be displayed to the user.

In some embodiments, the associations in the recommendation data store 132 are made based on viewing or consumption statistics 150 for subscriber accounts and may be individually weighted. These consumption statistics 150 may include behavioral data 152 including the consumption habits for particular time periods during a day, consumption history, frequency of use of the system, types of content items being played, metadata properties for the content being played, recorded shows, browsing history, etc. The consumption statistics 150 may also include feedback 128 from subscriber accounts regarding previously consumed content items or current content items in a personal linear channel. The associations may further specify not only whether to include the related content item in a personal linear channel for the particular user input 116, but also an ideal time to schedule the content item in the channel.

These consumption statistics 150 may also include an initial survey performed by the system for a subscriber account. When a subscriber first signs up for an account, the system may ask the subscriber for various preferences regarding the content that the user prefers to watch, the time of day the user prefers to watch particular content items, and may initially ask the user to rate a selection of content items.

Some of the associations in the recommendation data store 132 are based on consumption statistics of other subscriber accounts in the system. For example, the recommendation data store 132 may include associations between a user input 116 describing a particular theme, such as sci-fi, and various sci-fi shows that other subscribers have viewed frequently or have rated highly. Some of these associations are based on the consumption statistics 150 of the subscriber account providing the user input 116. For example, the recommendation data store 132 may include associations between a user input 116 describing a particular theme, such as cooking, and various cooking-related shows, and further associate certain cooking shows to certain timeslots based on the subscriber account's previous consumption habits. For example, shows about cuisines around the world may be shown during daytime slots, and how-to cooking shows may be shown before meal times as the user has previously selected to watch such how-to shows during these times.

In some embodiments, the associations are created based upon an analysis of the terms or phrases that may occur in an indicator of desired content against external sources of information. In some embodiments, these external sources of information include metadata regarding the available content items from the content sources, and may include sources such as the Internet. The system may use this analysis to associate related content items to different indicator terms or phrases. Each of these associations may have a separate weighting value. In order to make these associations, the system may further use the external sources of information to gather various attributes about the available content items that describe the various characteristics of the content item. For example, a content item, after analysis of the metadata related to that content item from the external sources of information, may be determined to have an attribute of “adventure.” Furthermore, these attributes may be weighted based on how strongly the analysis indicated the attribute applies to the content item. The system may then create the various associations between different possible terms and phrases that may be entered in the indicator of desired content and those content items that are associated most strongly with that indicator based on these gathered attributes. The system may also further associate some content items with each other based on a similarity or correlation between the attributes of each of the content items. Two associated content items may both then be displayed to the user if one of them is associated with a content item that the content item has selected for display or associated with a current indicator of desired content submitted by the user.

Exemplary user inputs 116 and the possible personal linear channels 134 that may be created from these user inputs 116 will be described below. These user inputs 116 may include a network selection 118, a theme selection 120, an actor selection 1220, a “binge” selection 124, and a keyword selection 126. The system may prompt the user for one or more of these user inputs 116 at different points in time during user interaction with the system, based on the actions of the user. Furthermore, in cases where the system may receive a user input 116 that may correspond to more than one type of selection, the system may be able to determine which selection the user has made based upon the content of the input 116. While exemplary user inputs 116 as shown in FIG. 1 are described below, the system is not limited to these user inputs 116 only and may accept additional types of user input 116 and may respond with a personal linear channel 134 customized to that input.

In some cases the system accepts a network selection 118 from the user to create a personal linear channel based on a particular network. A network, as described previously, is typically represented by a channel. An example of a network is HGTV® of Scripps Networks Interactive (Knoxville, Tenn.). In some embodiments, the system provides the subscriber with the option to customize his or her experience with that network channel. The system may cause a custom network channel that is a personal linear channel 134 for the user to appear next to the standard network channel in the subscriber's view of his or her program guide. The subscriber provides user input in the form of network selections 118 of the content items 136a-136n being played for that personal channel 134. For example, a user may be able to select a particular content item in the custom network channel as undesired and another content item as desired. Those content items which are marked as desired may receive positively weighted associations in the recommendation data store 132 for the custom channel 134 and those associations for the content items which are marked as undesired may be removed from the recommendation data store 132 for the subscriber. The custom network channel 134 will then include those content items 136 that still have associations within the recommendation data store 132.

In some embodiments, if the content item is part of a series, the system also determines whether the subscriber is making network selections 118 that are consistent over the entire series or over only particular content items in that series. If the selections 118 are over many content items of the series, the system may remove associations to the entire series from the recommendation data store 132 for that custom channel. If the selections 118 are patterned on particular content items within that series (e.g., particular episodes), then the system may determine whether a pattern exists for these selections 118 and modify those associations for those content items that match the pattern only. Patterns may include the particular content of each content item, the time that the content item is playing, whether the content item is a new material, the length of the content item, the genre of the item, etc. For example, a subscriber may only be selecting to remove episodes of a cooking show related to a particular food item, such as desserts. The system may then remove only the dessert related shows but preserve the other episodes of the show. In another embodiment, the system can divide a content item (e.g., an episode of a television series or a movie) into further segments. The system may then remove segments of the content item from the recommendation data store for that custom channel. Deep linking of segments of the content item results in much more granular channels and adds substantially more value to the user experience. As another example, the subscriber may be removing reruns of a show but not the original run of the show. In such a case, the system may stop showing reruns for that particular show. As another example, a user may be removing a news program when that news program is playing during the weekend but does not remove the news program when that program is playing during the weekday. The system may then only remove the news program from the custom channel during the weekends.

As the subscriber continues to provide network selections 118, the system will continue to modify the associations in the association database to reflect the network selections 118 such that the content 136 delivered and displayed on the custom network channel 134 is content that the subscriber desires to watch.

In some cases the system accepts a theme selection 120 or actor selection 122 from the user to create a personal linear channel 134 based on a particular theme or actor. The system may present an interface to the subscriber to allow the subscriber to submit a user input 116 specifying a theme selection 120 or actor selection 122. An example of a theme is mountain-bike racing. An example of an actor/person is Bobby Flay. Furthermore, the user may select a combination of these two. For example, the user may wish to watch cooking themed shows that include Bobby Flay.

Once the user enters a user input 116 including a theme or actor or combination, the system will consult recommendation data store 132 for the selected theme or actor. The data store 132 may include various associations between the theme and/or actor and other related content. These associations may have been generated based upon the consumption statistics of other subscribers. In some embodiments, the consumption statistics include what other content subscribers who watch cooking shows tend to also watch or consume; these other content items may be related to cooking. These associations may also have been generated through a manual process. For example, an administrator may have specifically added various cooking shows as associations to the theme cooking. These associations may also have been generated based upon the consumption statistics 150 of the subscriber, which may include the time of day a user watches a program, the frequency a user watches certain programs, and the time a user spends watching a program. In some embodiments, these associations may have also been generated based upon an analysis of the indicator against metadata from external sources of information. For example, the system may determine through this analysis that restaurant review programs are frequently associated with cooking programs from the metadata in the external sources of information. In such a case, the recommendation data store 132 may include associations between the theme of cooking and restaurant review content items.

In some embodiments, if the subscriber has entered more than one selection, such as when the subscriber enters a selection of a theme and an actor, the system may break these two or more selections apart and look them up separately in the data store 132. The resulting associations to related content may be matched with each other to find those that are shared in common between the two or more selections. In this way, the system is able to handle a search with multiple selection inputs simultaneously.

In some embodiments, the system also uses natural language processing to process the user input 116. The user input may include additional words and modifiers that may need to be considered, or may need to be discarded. The system will intelligently analyze the user input 116 to discard those words that pose no use and only search on those terms that are of use. The system may further be able to understand various synonyms and misspellings of user input 116 if the input is a text entry. The system may convert the synonyms and misspellings to terms that exist in the recommendation data store 132, and then find the content associated with these terms in the database. For modifiers or combinations of terms, the system may further match those related content items that are associated in common between the terms in the data store 132 and present these items to the subscriber.

In some cases a selection in the user input 116 may have multiple meanings. For example, the term “crane” may refer to a species of bird or a type of construction equipment. In such a case, in some embodiments, the system asks the user for clarification after the user enters the input that includes this selection which has multiple meanings. In some embodiments, the system consults the recommendation data store 132, which may have associated the term with the most likely definition that the subscriber is most likely to be interested in, based upon an analysis of prior consumption habits. The system may determine which one of the definitions is the most closely associated in the database with content that a subscriber has previously played in order to determine the most likely candidate meaning.

In some embodiments, the recommendation data store 132 may also contain associations with various “B-roll” content or content that is typically not aired by the content provider in a normal broadcast setting. This unaired material may instead be included in the theme/actor personal linear channel 134. A potential advantage of including this footage is that the content provider may now monetize this additional footage, and increase the time a subscriber spends consuming that content provider's content.

In some embodiments, since the theme/actor personal channel 134 is customized to a particular subscriber's theme selection 120 or actor selection 122, it may not play continuously. Instead, it may only play when the subscriber selects the channel to play, and may pause or stop playing when the subscriber has not selected the channel.

In some cases the system accepts a “binge” selection 124 from the user to create a personal linear channel 134 based on a particular show. In some embodiments, after the subscriber finishes playing one or more content items of a series, e.g., one or more episodes of a TV series, the system may prompt the subscriber to ask whether he or she would like to “binge,” or play the rest of the content items in the series consecutively. If the subscriber inputs a binge selection 124 indicating that he or she would like to play the entire series, the system will collect all the content items in that series to play in a personal linear channel 134 including the content items 136 of the series. In some embodiments, the subscriber can also directly specify to the system a binge selection 124 and the system, after receiving the selection, prepares a personal linear channel 134 including the content items 136 that are in that series.

In some embodiments, the recommendation data store 132 associates each content item in a series with a binge selector indicator, such that when the indicator 142 including the binge selection 124 indicator is passed to the recommendation data store 132, the database will select the various content items of that series. In many circumstances the content items in a series will not come from a single content source. Due to licensing issues and other factors, each of the various content sources 102 may only have some of the content items of a series. In this case, the recommendation data store 132 may include the source of each content item to allow the system to easily discover and locate which source contains which content items in the series and quickly retrieve these content items from the various sources.

In some embodiments, when a subscriber provides user input 116 which cannot be interpreted by the system, or which cannot be found by the system, or which results in very few associated content items, the system may further prompt the user for additional input. In the case of a text user input, the system may prompt the user to correct the spelling of a term, clarify the meaning of the term if it is ambiguous, or suggest other related but broader selections when the original input yields few results.

In some embodiments, the subscriber is allowed to provide user feedback 128 to the system for content items 136 selected for the personal linear channels 134. The subscriber may be able to provide a rating for each content item in the channel or may remove or add content items to the channel. When the user modifies the rating of content items or adds or removes content items from a channel, the system may additionally modify the associations to that rated, added, or removed content item in the recommendation data store 132, in relation to the associated user input selection within the recommendation data store 132. For example, if a subscriber removes a content item from a channel, then the system may remove the association between that content item and the user input used to create the channel in the recommendation data store 132. Note that this may only affect the particular subscriber that made the change, and will not affect other subscribers unless the system detects that the number of subscribers performing the same feedback action is beyond a certain threshold.

In some cases a personal linear channel 134 may include content items that are live broadcasts. In such cases, in some embodiments, the system will schedule the content items within the channel in such a way so that the live broadcast content item is played on the channel live and not time shifted.

In some embodiments the system may suggest personal linear channels 134 to the subscriber without the subscriber needing to initiate the creation of one. The system may determine through the subscriber's consumption statistics 150 or habits that a particular theme, series, actor, etc., is something the subscriber would be highly interested in. The system will then suggest a channel with this selection to the user. In some embodiments, the system may look up in the recommendation data store 132 the various content items the subscriber has played in the past to discover if they are commonly associated content items related to a particular theme, actor, etc., and will then suggest this as a channel to the user.

Note that while the system is described above with various exemplary user inputs, the system is not limited to these inputs, and may accept any other inputs such as any keyword selection 126, or any other input which may include text, visual, audio, or other media.

As described above, the system may cause a client device to display the personal linear channels 134 in a linear channel interface. This linear channel interface may also support a feedback interface mechanism. Although such a linear channel interface may be implemented in a variety of methods, some exemplary interfaces implementing a personal linear channel according to some embodiments of the invention are described below.

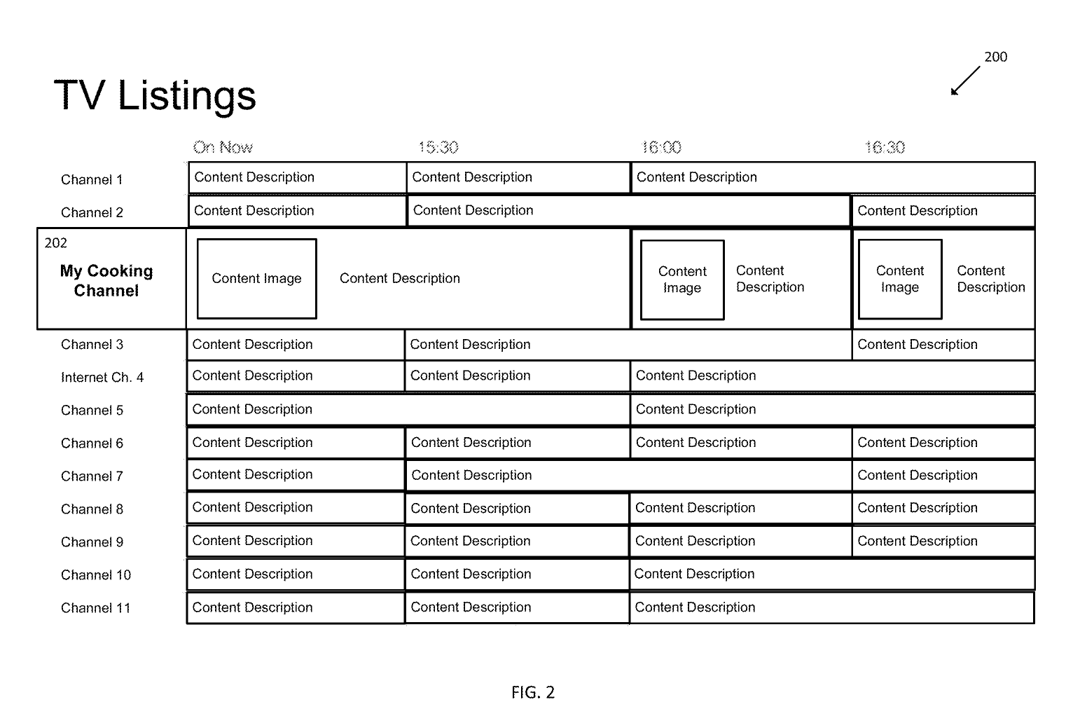

FIG. 2 illustrates an exemplary electronic programming guide (EPG) user interface 200 for a personal linear channel according to one embodiment of the invention. The EPG allows the user to see which programs can be watched by channel and time. In the exemplary interface 200, cooking theme related personal linear channel 134 has been created. As described previously, the system receives a user input 116 from a subscriber with a selection for the personal linear channel. This selection may be passed as an indicator 142 to server device 130. In the exemplary EPG 200, the user input 116 is a theme selection for cooking. The system selects the related content items associated with the user input 116 and presents them in the personal linear channel. This channel 202 is displayed in the EPG, along with other non-personal, regular broadcast channels. Although the personal channel 202 includes content items customized to a user input 116, and thus may not be present on another subscriber's system, it is still displayed alongside the regular channels in the EPG, as if it were part of a standard EPG list of channels.

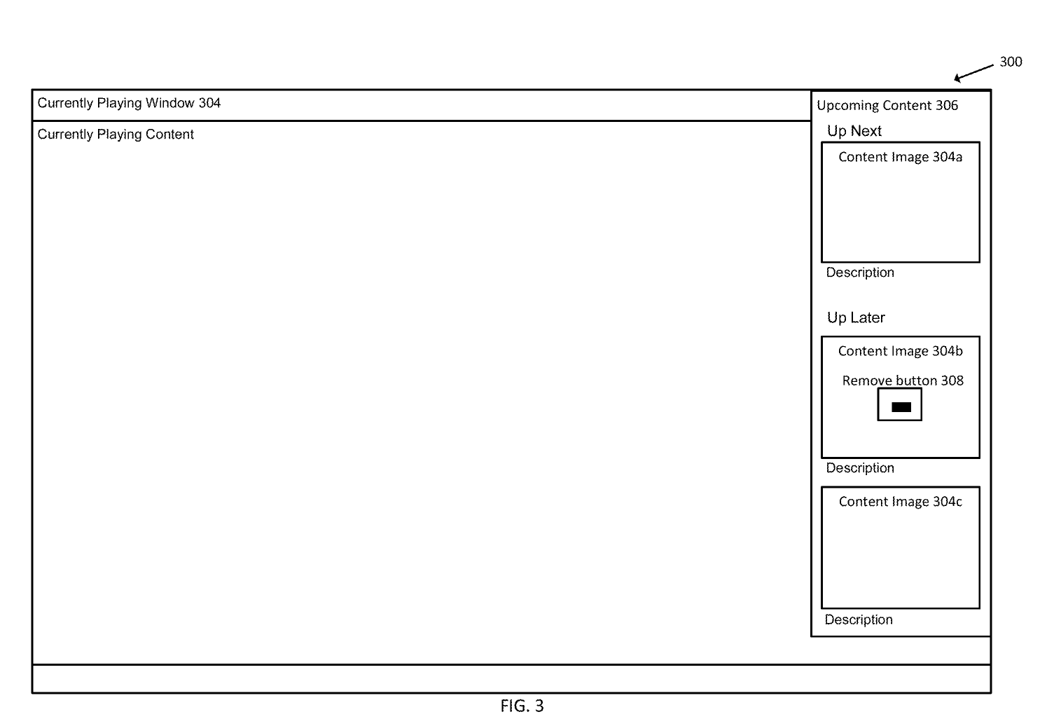

FIG. 3 illustrates an exemplary content item view user interface 300 for a personal linear channel according to one embodiment of the invention. In some embodiments, when the system receives a request from the user to fast forward, pause, stop, or skip the currently playing content, the system presents the user with a commercial in the currently playing window 304, and then also presents the user with an upcoming content window 306. The upcoming content window 306 displays the content that is scheduled or configured to play next after the currently playing content. This content is represented by the content images 304a-c and are described with a brief description underneath the content images 304. These content images 304 may be thumbnails, posters, or other images that help to describe the content.

In the upcoming content window 306, the system may further present the user with a remove button 308 when the system receives an interaction with the upcoming content 306 window, and specifically with a particular content image 304. In the exemplary view 300, the remove button 308 is overlaid over content image 304b. If the system receives an interaction from the user with the remove button 308 that is overlaid over a specific content image 304, the system will then remove the content represented by the content image 304 from the channel. In the exemplary view 300, if the system receives an interaction from the user with remove button 308, the system will then remove the content represented by content image 304b.

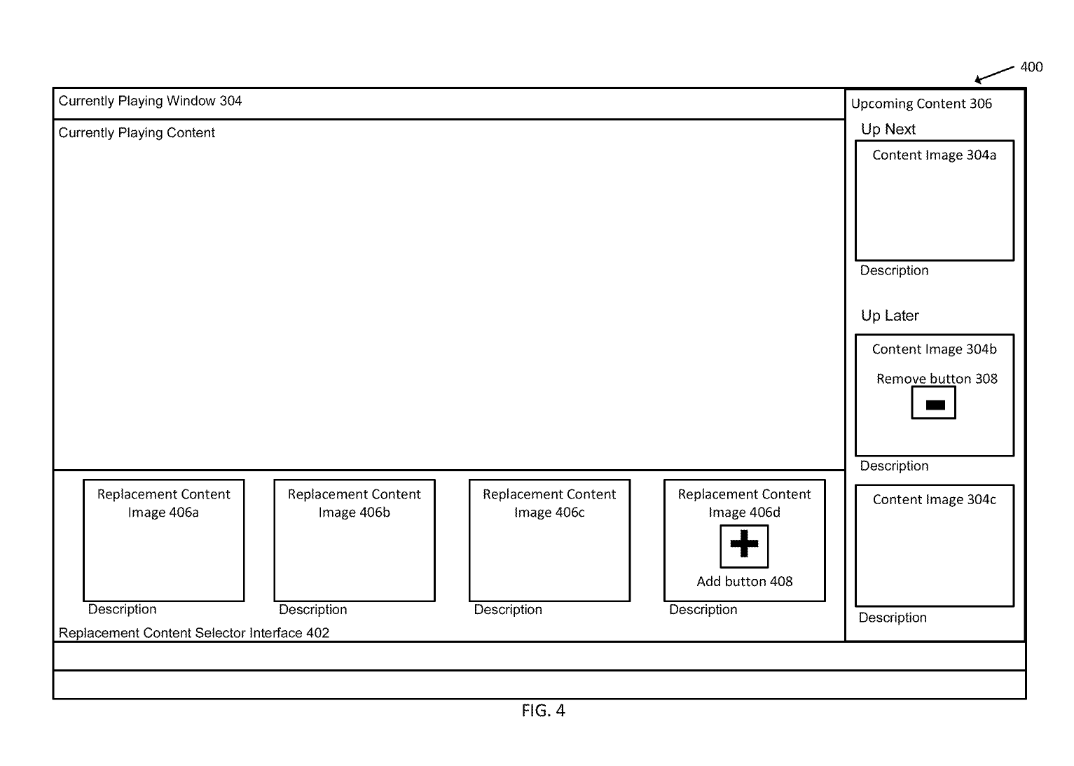

FIG. 4 illustrates another exemplary subsequent content item view user interface 400 for a personal linear channel according to one embodiment of the invention. While FIG. 3 illustrated an exemplary user interface for removal of a content item from a personal linear channel, FIG. 4 additionally illustrates the addition of a content item to replace the removed content item.

In some embodiments, after the system receives an interaction from the user with the remove button 308, the system presents the user with a replacement content selector interface 402. This selector interface 402 displays potential content items that the user may replace the content item to be removed (e.g., the content represented by content image 304b) with. In some embodiments, this replacement content selector interface 402 is also used to insert additional content items into an existing personal linear channel. When the system receives an interaction from the user with a particular content item represented by one of the replacement content images 406, the system will overlay an add button 408 on top of the replacement content image 406. If the system further receives an interaction by the user with this add button 408, the content item represented by the replacement content image 406 and overlaid by the add button 408 will be placed in the scheduled slot of the previous content item 304 that was removed. In the exemplary view 400, the content represented by content image 304b is set to be removed, and the content represented by replacement content image 406d is set to replace the removed content item.

In some embodiments, the content items selected to appear in the selector interface 402 are additional content items that have associations in the recommendation data store 132 with the user input used to create the channel being displayed. As described previously, these associations may be based on initially set preferences from the subscriber, consumption history and statistics 150 of the subscriber, and the content sources available to the subscriber.

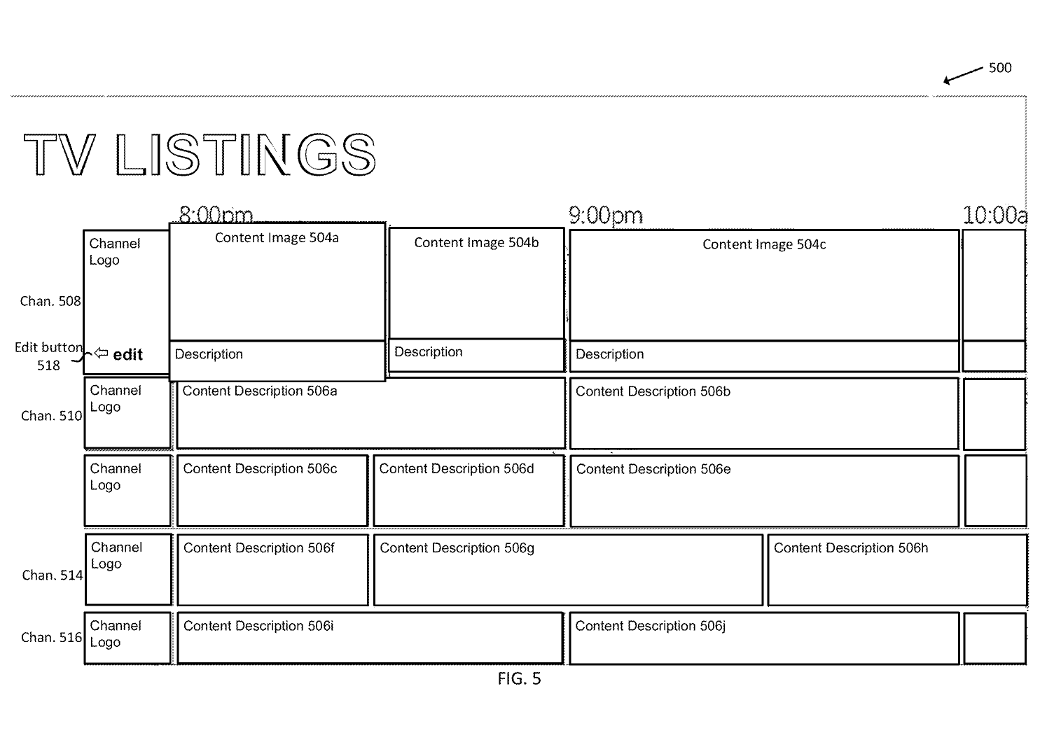

FIG. 5 illustrates another exemplary electronic programming guide (EPG) user interface 500 for a personal linear channel according to one embodiment of the invention. While FIG. 2 illustrated a personal linear channel based on a theme selection 120, FIG. 5 illustrates a personal linear channel based on a network selection 118.

In some embodiments, the system may receive a request to create a personal linear channel based on a network selection as described above. The system may display such personal linear channels based on network selections near the linear channels representing the original networks. In the exemplary EPG 500, channel 508 is the customized personal linear channel based on the network represented by channel 510. Although the content, represented by the content images 504 and descriptions 506, from personal channel 508 and channel 510 may be broadcast by the same network, the actual order, frequency, scheduling, etc., of the content in personal channel 508 will be customized to the subscriber as described above. In some embodiments, in order to provide the content for the personal linear channel 508, the system acquires the content for the personal channel 508 not only from network source 104 but also from other content sources.

The system may also support multiple personal linear channels based on a network selections 118. For example, in the exemplary EPG 500, in addition to the personal channel 508 based off the network of channel 510, the system also includes a personal channel 514 based off the network represented by channel 516. In some embodiments, these personal channels are labeled by the name of the network prefixed additionally by the label “My”.

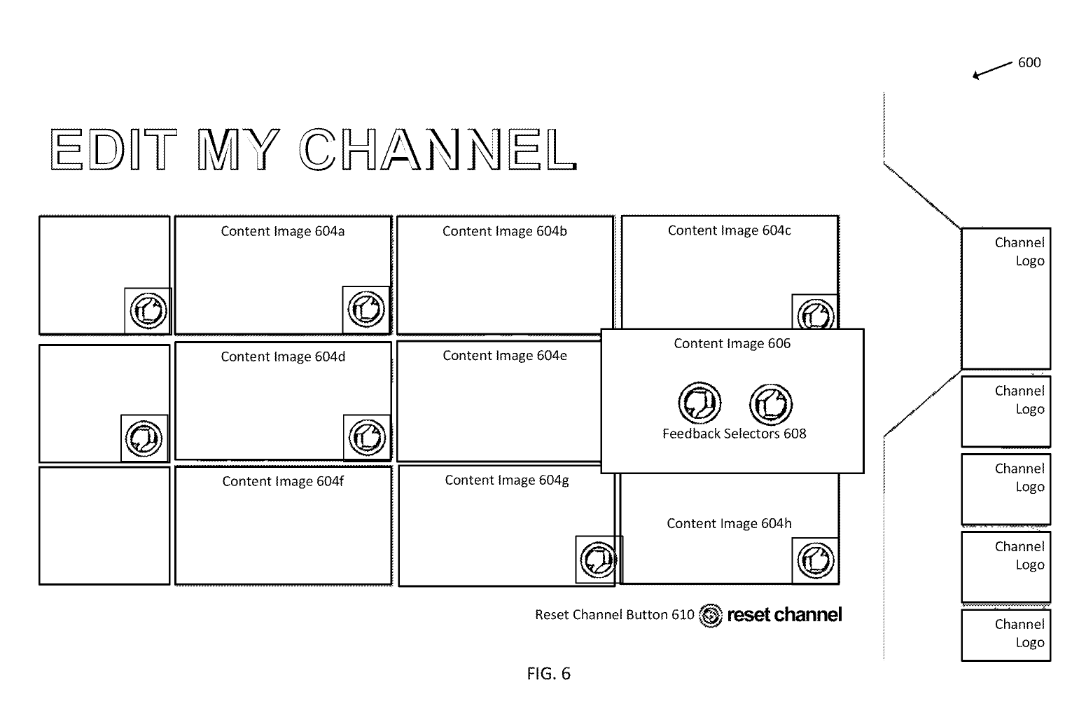

In some embodiments, the system allows the user to directly edit a personal linear channel by interacting with an edit button, such as edit button 518. When the system receives an interaction from the user with edit button 518, the system presents the user with an edit interface, where the user may add and delete content items from the personal channel as described above for FIG. 1. An exemplary edit user interface is described below for FIG. 6.

FIG. 6 illustrates an exemplary channel edit user interface 600 for a personal linear channel according to one embodiment of the invention. After the system receives a user interaction with an edit button 518 for a channel, the system may present the user with a channel edit user interface 600.

In some embodiments, some or all of the content items that are shown for the personal channel are displayed in the channel edit user interface, each represented by a content image 604. The system may be able to receive directional input from the user and may respond by scrolling the channel edit user interface 600 to display additional content items that are part of the channel but which cannot all be displayed at once. The system may receive interaction from the user with each content image, at which point the system will display that content image with additional feedback selectors 608. In some embodiments, these feedback selectors 608 are represented by a thumbs up and a thumbs down icon. Having two feedback selectors allows a user three potential choices. A user may choose to select the positive selector (e.g., thumbs up) indicating that the user likes the content item, may choose to select the negative selector (e.g., thumbs down) indicating that the user dislikes the content item, or may not choose any of the selectors. If the system receives a negative selection for a content item, then the system will remove that content item from the selection and may replace it with a content item as selected based on the methods described above. If the system receives a positive selection, then the system may show that content item and content items that are related to that content item more frequently. Content items that are related may be determined by the recommendation data store 132 as described above. In some embodiments, the feedback selectors 608 include more than two options, and may further include a rating option. In such an embodiment, the system may take the rating into account in determining which content items to show more, less, or to remove completely.

In some embodiments, channel edit user interface 600 also includes a reset channel button 610. When the system receives an interaction from the user with this button, the system may confirm with the user on the reset, and if the user answers in the affirmative, the system may then reset the content item selections and feedback for the personal linear channel back to a default state. This default state may be the state of the channel when it was first created.

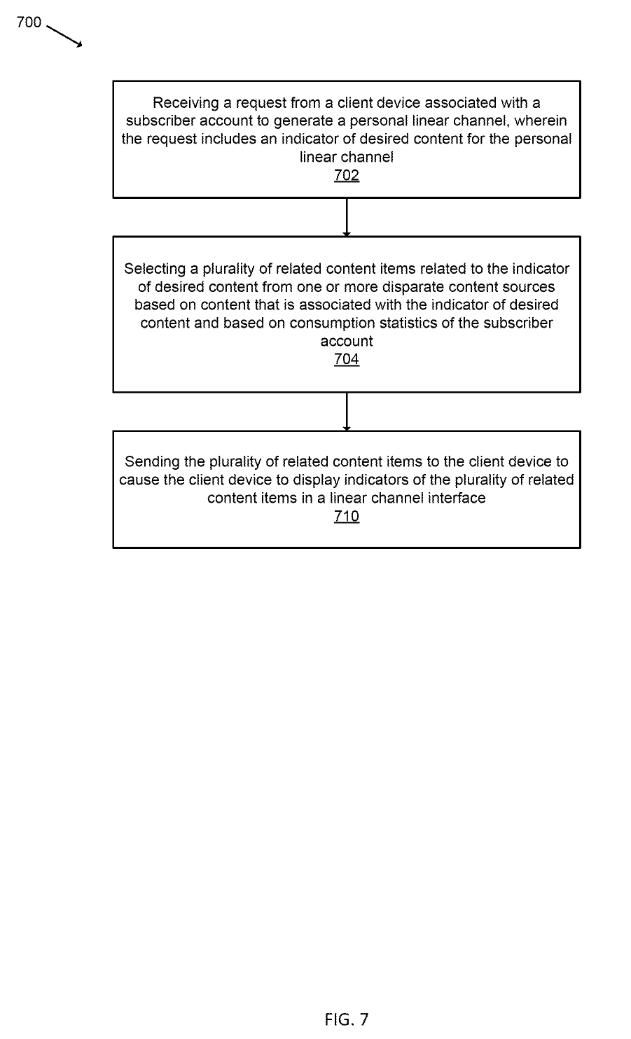

FIG. 7 is a flow diagram illustrating a method 700 in a server device for generating a personal linear channel according to an embodiment of the invention. In some embodiments, this method is performed by server device 130. At 702, the method includes receiving a request from a client device associated with a subscriber account to generate a personal linear channel, wherein the request includes an indicator of desired content for the personal linear channel.

At 704, the method includes Selecting a plurality of related content items related to the indicator of desired content from one or more disparate content sources based on content that is associated with the indicator of desired content and based on consumption statistics of the subscriber account. In some embodiments, the consumption statistics of the subscriber account are consumption statistics 150.

At 710, the method includes sending the plurality of related content items to the client device to cause the client device to display indicators of the plurality of related content items in a linear channel interface.

Although the flow diagrams in the figures show a particular order of operations performed by certain embodiments of the invention, it should be understood that such order is exemplary (e.g., alternative embodiments may perform the operations in a different order, combine certain operations, overlap certain operations, etc.).

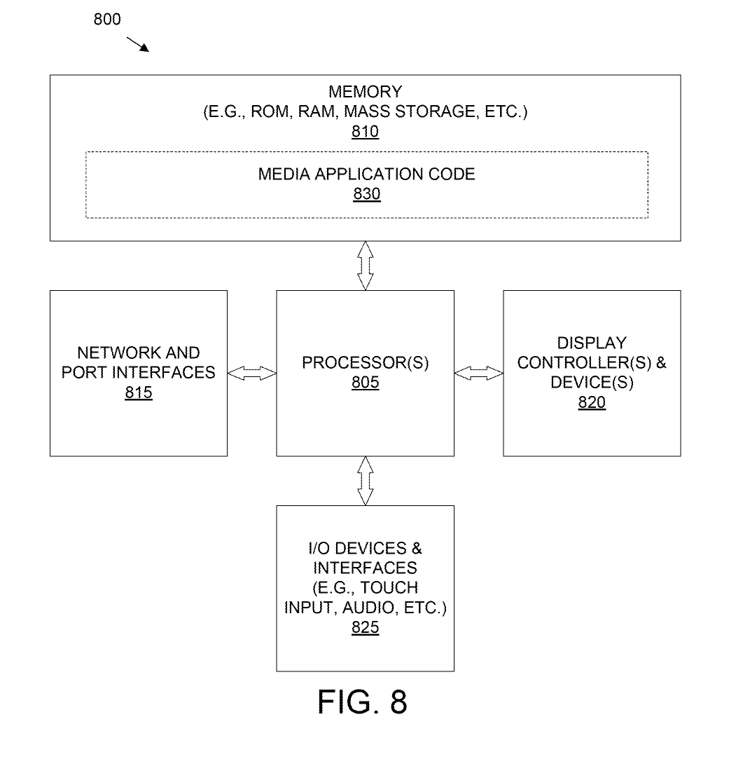

FIG. 8 illustrates a block diagram for an exemplary data processing system 800 that may be used in some embodiments. Data processing system 800 includes one or more microprocessors 805 and connected system components (e.g., multiple connected chips). Alternatively, the data processing system 800 is a system on a chip. One or more such data processing systems 800 may be utilized to implement the functionality of the client devices, server computing devices 130, and/or content servers for content sources 102, as illustrated in FIG. 1.

The data processing system 800 includes memory 810, which is coupled to the microprocessor(s) 805. The memory 810 may be used for storing data, metadata, and programs for execution by the microprocessor(s) 805. For example, the depicted memory 810 may store media application code 830 that, when executed by the microprocessor(s) 805, causes the data processing system 800 to perform the operations described herein. The memory 810 may include one or more of volatile and non-volatile memories, such as Random Access Memory (“RAM”), Read Only Memory (“ROM”), a solid state disk (“SSD”), Flash, Phase Change Memory (“PCM”), magnetic storage, or other types of data storage. The memory 810 may be internal or distributed memory. In some embodiments, a portion or all of the media application code 830 is stored on an external cloud device.

The data processing system 800 may also include a display controller and display device 820 that provides a visual user interface for the user, e.g., GUI elements or windows. The display device 820 may also display various media content to the user. The data processing system 800 also includes one or more input or output (“I/O”) devices and interfaces 825, which are provided to allow a user to provide input to, receive output from, and otherwise transfer data to and from the system. These I/O devices 825 may include a mouse, keypad, keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 800. The I/O devices and interfaces 825 may also include a connector for a dock or a connector for a USB interface, FireWire, Thunderbolt, Ethernet, etc., to connect the system 800 with another device, external component, or a network. Exemplary I/O devices and interfaces 825 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 800 with another device, external component, or a network and receive stored instructions, data, tokens, etc. In some embodiments, these various components will be provided as a system on a chip (SoC). It will be appreciated that one or more buses may be used to interconnect the various components shown in FIG. 8.

For example, the data processing system 800 may be a personal computer (PC), tablet-style device, a personal digital assistant (PDA), a cellular telephone (e.g., smartphone), a Wi-Fi based telephone, a handheld computer which may optionally include a cellular telephone, a media player, an entertainment system, a handheld gaming system, a wearable computing device (e.g., smartwatch, digital eyewear), or devices which combine aspects or functions of these devices, such as a media player combined with a PDA and a cellular telephone in one device. In other embodiments, the data processing system 800 may be a network computer, server, or an embedded processing device within another device or consumer electronic product. As used herein, the terms computer, system, device, processing device, and “apparatus comprising a processing device” may be used interchangeably with the term data processing system 800 and include the above-listed exemplary embodiments.

It will be appreciated that additional components, not shown, may also be part of the system 800, and, in certain embodiments, fewer components than that shown in FIG. 8 may also be used in a data processing system 800. For example, in some embodiments where the data processing system 800 is a set top box, the set top box may include components such as a digital broadcast receiver (e.g., satellite dish receiver, radio frequency (RF) receiver, microwave receiver, multicast listener, etc.) and/or a tuner that tunes to appropriate frequencies or addresses of received content. For example, a tuner may be configured to receive digital broadcast data in a particularized format, such as MPEG-encoded digital video and audio data, as well as digital data in many different forms, including software programs and programming information in the form of data files. As another example, the set top box may include a key listener unit to receive authorization and/or session keys transmitted from a server. The keys received by listener unit may be used by cryptographic security services implemented in a protection mechanism in the set top box to enable decryption of the session keys and data.

The set top box may further include components such as an encryption and/or decryption integrated circuit to decrypt incoming signals from the network and encrypt outgoing media signals to a display device. The digital set top box may also include a receptacle to receive an encryption key store that includes the encryption keys used to decrypt incoming signals. The set top box may further include a Wi-Fi, Bluetooth, infrared, or other input method to receive input from a controller device such as a keyboard, a remote, a mobile application on a smartphone, etc.

It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 810 or other non-transitory machine-readable storage medium. The software may further be transmitted or received over a network (not shown) via a network and/or port interface 815. In various embodiments, hardwired circuitry may be used in combination with the software instructions to implement the present embodiments. Thus, the techniques are not limited to any specific combination of hardware circuitry and software, or to any particular source for the instructions executed by the data processing system 800.

An electronic device, such as the client devices, server computing devices, and/or content servers described herein, stores and transmits (internally and/or with other electronic devices over a network) code (which is composed of software instructions and which is sometimes referred to as computer program code) and/or data using machine-readable media, such as non-transitory machine-readable media (e.g., machine-readable storage media such as magnetic disks, optical disks, read only memory, flash memory devices, phase change memory) and transitory machine-readable transmission media (e.g., electrical, optical, acoustical or other form of propagated signals—such as carrier waves, infrared signals). Thus, an electronic device (e.g., a computer) includes hardware and software, such as a set of one or more processors coupled to one or more non-transitory machine-readable storage media (to store code for execution on the set of processors and data) and a set or one or more physical network interface(s) to establish network connections (to transmit code and/or data using propagating signals). One or more parts of an embodiment of the invention may be implemented using different combinations of software, firmware, and/or hardware.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a server device, comprising:
receiving a request from a client device associated with a subscriber account to generate a personal linear channel, wherein the request includes an indicator of desired content for the personal linear channel;
selecting a plurality of related content items related to the indicator of desired content from one or more disparate content sources based on content that is associated with the indicator of desired content and based on consumption statistics of the subscriber account;
sending the plurality of related content items to the client device to cause the client device to display indicators of the plurality of related content items in a linear channel interface.

2. The method of claim 1, wherein the one or more disparate content sources include one or more of: a network source providing live content, a television operator video on demand source, a third party provider content aggregator Internet source, a third party provider content owner Internet source, a digital video recorder of the subscriber account, an advertisement source, and a television operator restart television source.

3. The method of claim 1, wherein the indicator of desired content is one of a network selection, a theme selection, an actor selection, a binge selection, and a keyword selection.

4. The method of claim 1, wherein the selected plurality of related content items includes one or more content items that are each associated with metadata related to the indicator of desired content.

5. The method of claim 4, wherein the metadata associated with the one or more content items is received from one or more remote sources of metadata.

6. The method of claim 1, wherein the consumption statistics of the subscriber account includes feedback of content items in the linear channel interface from a user of the subscriber account.

7. The method of claim 6, wherein the consumption statistics of the subscriber account further includes a frequency, time of day, genre, and duration of content items consumed by the user of the subscriber account.

8. The method of claim 1, wherein selecting the plurality of related content items related to the indicator of desired content from the plurality of disparate content sources is further based on consumption statistics of other subscriber accounts including a frequency, time of day, and duration of content items consumed by users of the other subscriber accounts.

9. A non-transitory computer-readable storage medium having instructions stored therein, wherein the instructions, when executed by a processor of a server device, cause the processor to perform operations comprising:
receiving a request from a client device associated with a subscriber account to generate a personal linear channel, wherein the request includes an indicator of desired content for the personal linear channel;
selecting a plurality of related content items related to the indicator of desired content from one or more disparate content sources based on content that is associated with the indicator of desired content and based on consumption statistics of the subscriber account;
sending the plurality of related content items to the client device to cause the client device to display indicators of the plurality of related content items in a linear channel interface.

10. The non-transitory computer-readable storage medium of claim 9, wherein the one or more disparate content sources include one or more of: a network source providing live content, a television operator video on demand source, a third party provider content aggregator Internet source, a third party provider content owner Internet source, a digital video recorder of the subscriber account, an advertisement source, and a television operator restart television source.

11. The non-transitory computer-readable storage medium of claim 9, wherein the indicator of desired content is one of a network selection, a theme selection, an actor selection, a binge selection, and a keyword selection.

12. The non-transitory computer-readable storage medium of claim 9, wherein the selected plurality of related content items includes one or more content items that are each associated with metadata related to the indicator of desired content.

13. The non-transitory computer-readable storage medium of claim 12, wherein the metadata associated with the one or more content items is received from one or more remote sources of metadata.

14. The non-transitory computer-readable storage medium of claim 9, wherein the consumption statistics of the subscriber account includes feedback of content items in the linear channel interface from a user of the subscriber account.

15. The non-transitory computer-readable storage medium of claim 14, wherein the consumption statistics of the subscriber account further includes a frequency, time of day, genre, and duration of content items consumed by the user of the subscriber account.

16. The non-transitory computer-readable storage medium of claim 9, wherein selecting the plurality of related content items related to the indicator of desired content from the plurality of disparate content sources is further based on consumption statistics of other subscriber accounts including a frequency, time of day, and duration of content items consumed by users of the other subscriber accounts.
